(19) United States
(12) Patent Application Publication
(10) Pub. No.: US 2012/0163357 A1
(43) Pub. Date: Jun. 28, 2012

(54) METHOD OF RETRANSMITTING AND RECEIVING PACKETS IN HETEROGENEOUS NETWORK ENVIRONMENT

(75) Inventors: Seok Ho WON, Daejeon (KR); Sun Hyoung Kwon, Seoul (KR); Ho Kyom Kim, Daejeon (KR); Jong Soo Lim, Daejeon (KR); Jin Woo Hong, Daejeon (KR)

(73) Assignee: Electronics and Telecommunications Research Institute, Daejeon (KR)

(21) Appl. No.: 13/326,193

(22) Filed: Dec. 14, 2011

(30) Foreign Application Priority Data
Dec. 24, 2010 (KR) 10-2010-0134835
Dec. 7, 2011 (KR) 10-2011-0130094

(51) Int. Cl. H04W 92/00

(52) U.S. Cl. 370/338

(57) ABSTRACT

Provided is a method of retransmitting and receiving a packet in heterogeneous network environment. A terminal and a relay base station receive a packet transmitted from a macro base station, and the relay base station informs the terminal of whether the packet is successively received or not. When the packet fails to be received, the terminal is configured to receive the erroneous packet again from at least one of the macro base station and the relay base station. The macro base station and the relay base station may be configured to retransmit the packet through joint processing JP) transmission, and the terminal may be configured to receive the JP transmission. Thus, the method allows the m optimization of a HARQ process and scheduling scheme to efficiently utilize a relay and radio resources, thereby leading to a maximum capacity and quality of wireless network.

### CLAIM FOR PRIORITY

This application claims priority to Korean Patent Application No. 10-2010-0134835 filed on Dec. 24, 2010 and No. 10-2011-0130094 file on Dec. 7, 2011 in the Korean Intellectual Property Office (KIPO), the entire contents of which are hereby incorporated by reference.

### BACKGROUND

1. Technical Field

Example embodiments of the present invention relate in general to methods of retransmitting and receiving packets in a heterogeneous network environment, and more specifically, to methods of packet retransmission and reception of a base station and a terminal capable of efficient hybrid ARQ (HARQ) retransmission in a heterogeneous network environment in which a macrocell and a picocell using a relay overlap.

2. Related Art

A heterogeneous network environment is an environment in which cell coverage of a base station (a high power node) requiring relatively high transmission power and cell coverage of a base station (a low power node) requiring relatively low transmission power overlap.

In such a heterogeneous network environment, a coexistence of a high power node and a low power node may cause undesirable effects such as interference. On the other hand, terminals located within an area where coverage of a macrocell of a macro base station and coverage of a picocell employing a relay base station overlap in a heterogeneous network environment can simultaneously receive signals transmitted from the macro base station and the relay base station.

In such a case, when the terminal fails to normally receive a packet transmitted from the macro base station or when the macro base station fails to normally receive a packet transmitted from the terminal, retransmission according to a HARQ process will be performed.

Although the HARQ process is now defined in 3GPP LTE standard, unlike an environment where only a macro base station and a terminal are located, in an environment including the relay base station in addition to the macro base station and the terminal, a HARQ retransmission process through the relay base station has not been yet defined.

### SUMMARY

Accordingly, example embodiments of the present invention are provided to substantially obviate one or more problems due to limitations and disadvantages of the related art.

Example embodiments of the present invention provide a method of packet retransmission suitable for a heterogeneous network environment which can improve the efficiency of radio resources by minimizing the waste of radio resources and implementing efficient packet retransmission in a heterogeneous network environment for high speed, high capacity wireless communications.

Example embodiments of the present invention also provide a method of packet retransmission of a terminal which can improve the efficiency of radio resources by minimizing the waste of radio resources and implementing efficient packet retransmission in a heterogeneous network environment for high speed, high capacity wireless communications.

Example embodiments of the present invention also provide a method of packet retransmission of a base station which can improve the efficiency of radio resources by minimizing the waste of radio resources and implementing efficient packet retransmission in a heterogeneous network environment for high speed, high capacity wireless communications.

In some example embodiments, a method of retransmitting a packet in a heterogeneous network environment, includes: transmitting, by a first base station, a packet to a terminal and a second base station; informing, by the second base station, the terminal whether the packet is received normally or not; and informing, by the terminal, the first base station and the second base station whether the packet is received normally or not.

In a particular embodiment, coverage of the second base station may overlap coverage of the first base station, and the terminal may be located within the coverage of the first and m second base stations. In such a case, the first base station may be a macrocell base station, and the second base station may be at least one of a relay base station, a relay terminal, a picocell base station and a femtocell base station capable of receiving the packet transmitted from the first base station.

In a particular example, the method may further include buffering the packet when the second base station receives the packet normally.

In a particular embodiment, when the terminal informs the first base station and the second base station whether the packet is received normally or not, if a determination result of whether the packet is received normally or not is a NACK, the terminal may inform the first base station and the second base station of information designating a base station to perform the packet retransmission. In such a case, when the second base station informs the terminal that the packet has failed to be received normally, the terminal may exclude the second base station of the base stations from performing the packet retransmission. In such a case, the method may further include retransmitting the packet to the terminal by a base station of the first base station and the second base station using information designating the base station to perform the packet retransmission.

In a particular embodiment, the method may further include simultaneously retransmitting the packet, by the first base station and the second base station, using the same time-frequency resource through joint processing (JP).

In other example embodiments, a method of receiving a packet in a heterogeneous network environment as an operating method of the terminal located within overlapping coverage of a first base station and a second base station, includes: receiving a packet transmitted from the first base station; receiving a notification of whether the packet transmitted from the first base station is received normally or not from the second base station; informing the first base station and the second base station whether the packet is received normally or not; and receiving, when a determination result of whether the packet is m normally received or not is a NACK, the packet from at least one base station of the first base station and the second base station.

In a particular embodiment, the first base station may be a macrocell base station, and the second base station may be at least one of a relay base station, a relay terminal, a picocell base station and a femtocell base station capable of receiving the packet transmitted from the first base station.

In a particular embodiment, when the terminal informs the first base station and the second base station whether the packet is received normally or not, if a determination result of whether the packet is normally received or not is a NACK, the terminal may inform the first base station and the second base station of information designating a base station to perform packet retransmission. In such a case, when the terminal is notified that the packet has not received normally from the second base station, the terminal may exclude the second base station of the base stations from performing the packet retransmission.

In a particular embodiment, the receiving of the packet from at least one of the first base station and the second base station may include simultaneously receiving the packet from the first base station and the second base station using the same time-frequency resource through joint processing (JP).

In still other example embodiments, a method of retransmitting a packet at a base station in a heterogeneous network environment, includes: transmitting a packet to a terminal located within coverage of its base station and another base station different from the base station, the coverage of the other base station being overlapping coverage of the base station; receiving a notification of whether the packet is received normally or not from the terminal; and retransmitting the packet in response to an instruction by the terminal.

In a particular embodiment, the base station may be a macrocell base station, and the other base station may be at least one of a relay base station, a relay terminal, a picocell base station and a femtocell base station capable of receiving the packet transmitted from the base station.

In a particular embodiment, the retransmitting of the packet may include simultaneously retransmitting, by the base station, the packet together with the other base station using the same time-frequency resource through joint processing (JP).

In yet other example embodiments, a method of retransmitting a packet at a base station in a heterogeneous network environment, includes: receiving a packet transmitted to a terminal located within coverage of the base station from another base station different from the base station, the coverage of the other base station overlapping coverage of the base station; informing the terminal whether the packet is received normally or not; and retransmitting the packet in response to an instruction by the terminal.

In a particular embodiment, the base station may be at least one of a relay base station, a relay terminal, a picocell base station and a femtocell base station capable of receiving the packet transmitted from the other base station.

In a particular embodiment, the method may further include buffering the packet when the base station successfully receives the packet.

In a particular embodiment, the retransmitting of the packet may include simultaneously retransmitting, by the base station, the packet together with the other base station using the same time-frequency resource through joint processing (JP).

### BRIEF DESCRIPTION OF DRAWINGS

Example embodiments of the present invention will become more apparent by describing in detail example embodiments of the present invention with reference to the accompanying drawings, in which:

FIG. 1 is a flow chart for explaining a method of packet retransmission in a heterogeneous network environment according to an embodiment of the present invention.

FIG. 3, FIG. 4, FIG. 5, FIG. 7, FIG. 9 and FIG. 10 each show a conceptual diagram for explaining a method of packet retransmission in a heterogeneous network environment according to an embodiment of the present invention.

FIG. 2, FIG. 6 and FIG. 8 each show a timing diagram for explaining a method of packet retransmission in a heterogeneous network environment according to an embodiment of the present invention.

FIG. 11 is a flow chart for explaining a method of packet reception of a terminal in a heterogeneous network environment according to an embodiment of the present invention.

FIG. 12 is a flow chart for explaining an example of a method of packet retransmission of a base station in a heterogeneous network environment according to an embodiment of the present invention.

FIG. 13 is a flow chart for explaining another example of a method of packet retransmission of a base station in a heterogeneous network environment according to an embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the specification, a “terminal” may indicate a mobile station (MS), a user equipment (UE), a user terminal (UT), a wireless terminal, an access terminal (AT), a terminal device, a subscriber unit, a subscriber station (SS), a wireless device, a wireless communication device, a wireless transmit/receive unit (WTRU), a mobile node, a mobile, or the like. A variety of examples of the terminal not only include a cellular phone, a smart phone with wireless communication capability, a personal digital assistant (PDA) with wireless communication capability, a wireless modem, a portable computer with wireless communication capability, an imaging device such as a digital camera with wireless communication capability, a gaming apparatus with wireless communication capability, home appliances capable of storing and playing music with wireless communication capability, internet equipments capable of wireless internet access and browsing, but also include portable units or terminals which can incorporate any combinations of the capabilities, but m examples are not limited thereto.

In the specification, a “base station” may indicate a fixed or moving station which may be in communication with a terminal and may be also referred to as a wireless communication station, node B (Node-B), e node B (eNode-B), a base transceiver system (BTS), an access point, a relay, a femto-cell, and so on.

Hereinafter, specific embodiments of the present invention will be described in detail with reference to the accompanying drawings. Like numbers refer to like elements throughout the description of the figures.

A method of packet retransmission and reception in a heterogeneous network environment according to an embodiment of the present invention is a technique for improving an efficiency of radio resources in a heterogeneous network wireless service environment in which coverage of a macrocell and coverage of a picocell overlap in order to perform high speed, high capacity wireless communications. In particular, an embodiment of the present invention is a technique suitable for being applied to 3GPP LTE-Advanced standard as a leader of IMT-Advanced system and future possible standards. In an example, an embodiment of the present invention may also be applied to the standards such as IEEE802.16m and IEEE802.16j designed by considering a heterogeneous network environment (in particular, a heterogeneous network environment including a relay device), like 3GPP LTE-Advanced.

Furthermore, an embodiment of the present invention utilizes functionalities already defined in the 3GPP LTE-Advance specification, for example, dynamic cell selection (DCS) and joint processing (JP) schemes in cooperative multi-point (CoMP) transmission techniques, and thus provides a method capable of high speed and large capacity wireless services by efficiently utilizing wireless resources.

In the following description, for clarity of explanation, an example of data transmission performed in forward link or downlink will be described. Specifically, in the following exemplary embodiment, it will be described that data is transmitted from a base station (or donor base station (DeNB)) toward a terminal (or user equipment (UE)) or a relay. Moreover, in a HARQ process known from standard specifications such as 3GPP, it is assumed that acknowledgement (ACK) and non-ACK (NACK) signals are transmitted in a backward direction (from terminal toward base station or relay).

However, an embodiment of the present invention may be also employed when data is transmitted in backward link or uplink. In this case, ACK/NACK signals are transmitted toward a terminal in a network. In other words, in the following description, it will be described that a terminal transmits ACK/NACK signals for a packet transmitted from a base station and the base station performs packet retransmission. Moreover, an embodiment of the present invention may be applied equally when the base station transmits ACK/NACK signals for a packet transmitted from the terminal and the terminal performs packet retransmission.

In the following description, common notations are used as follows: in an expression Mf(t, i) for representing resources of a macrocell, t is an index indicating time, and i is an index indicating the order of packets. Similarly, in an expression Pf(t, i), t is an index indicating time, and i is an index indicating the order of packets.

As referred to hereinafter, a method of packet retransmission in a heterogeneous network environment will be described, and then methods for operations of individual base stations and a terminal constituting a system will be described respectively in term of an overall system.

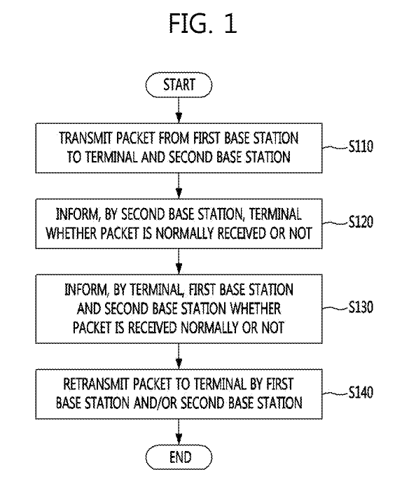

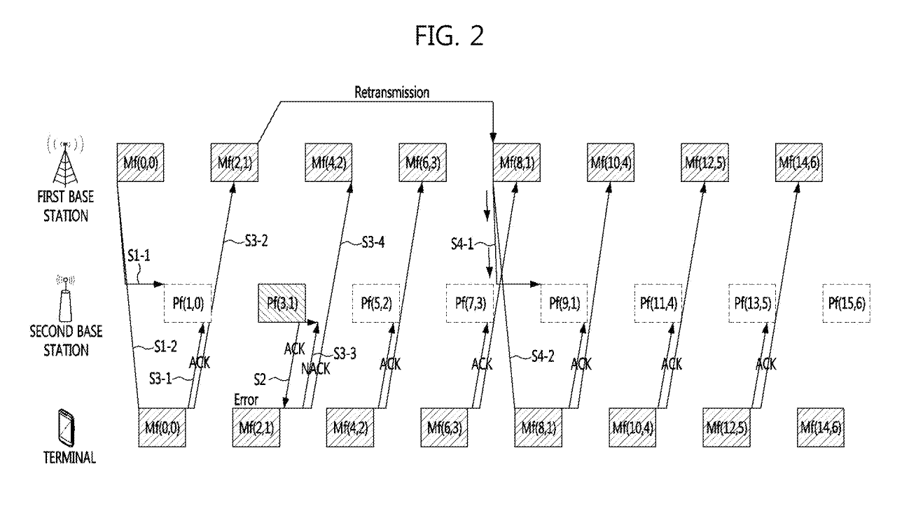

FIG. 1 is a flow chart for explaining a method of packet retransmission in a heterogeneous network environment according to an embodiment of the present invention.

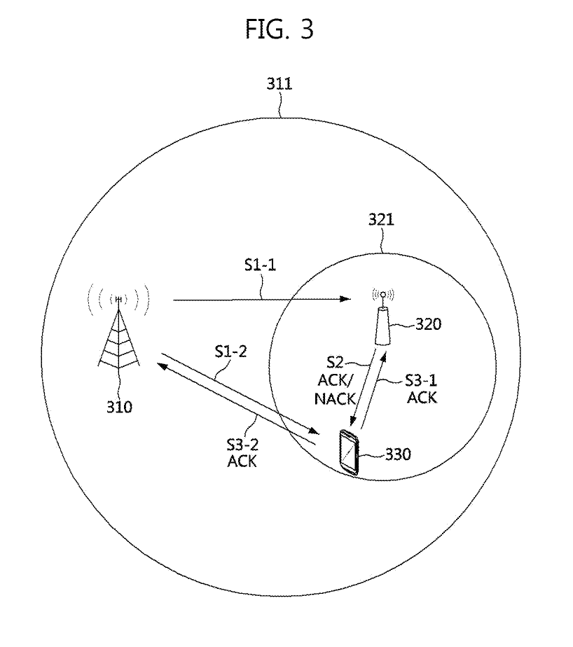

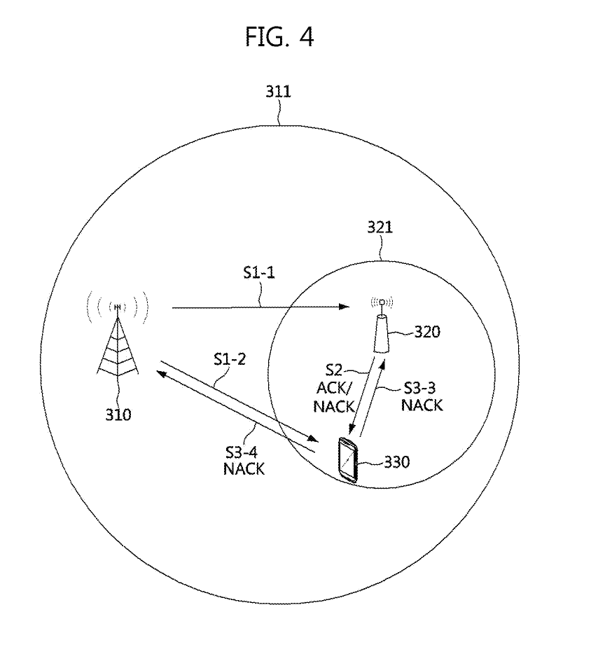

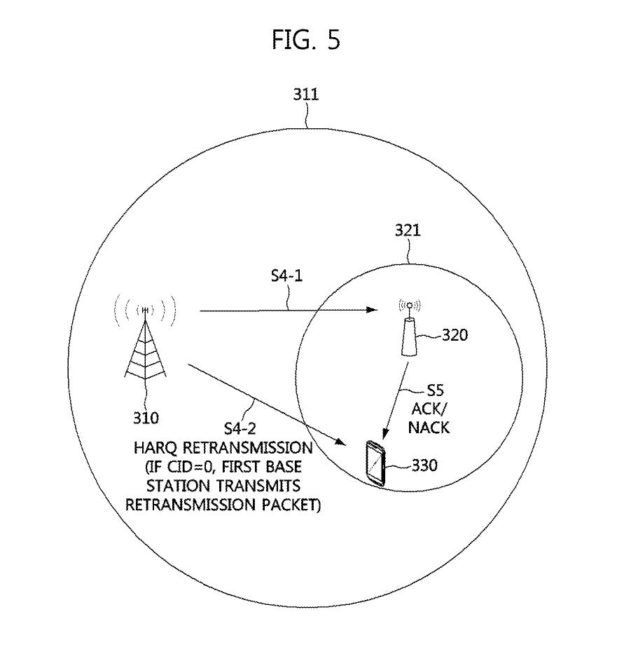

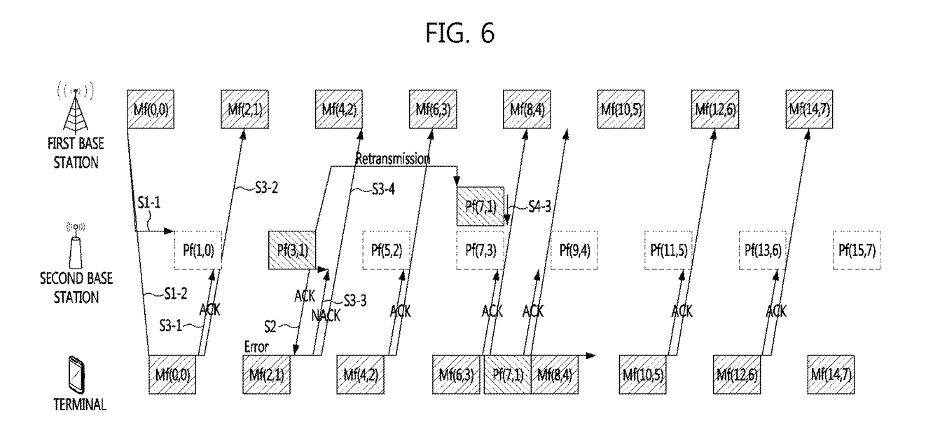

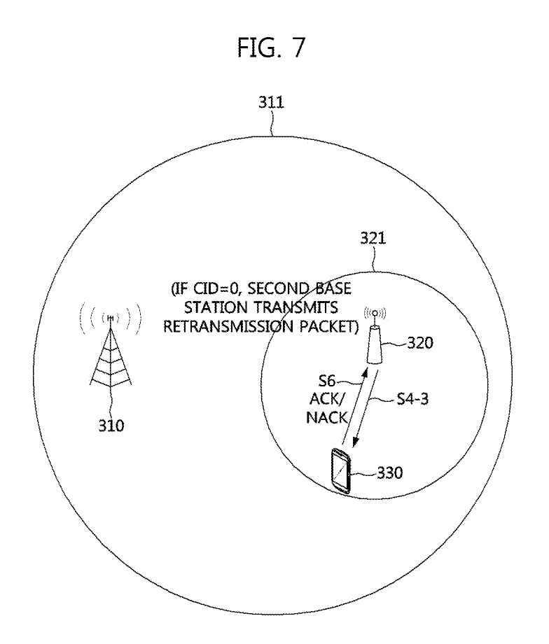

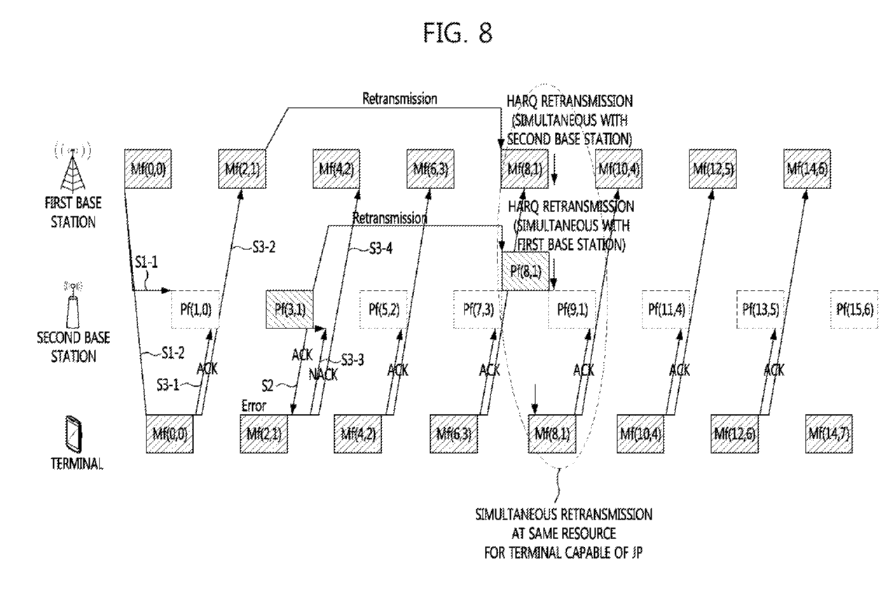

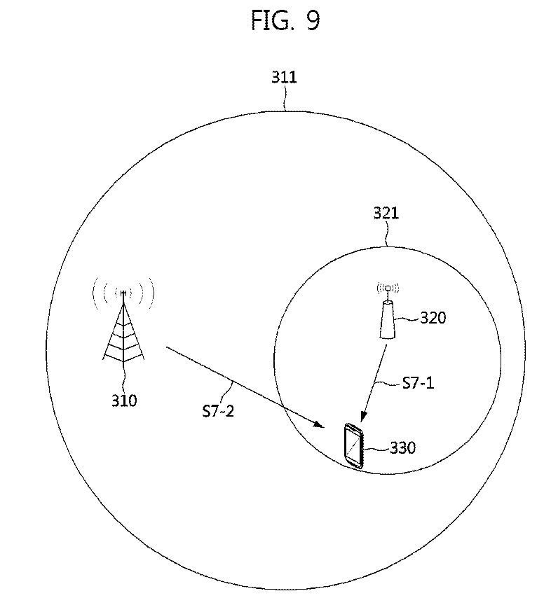

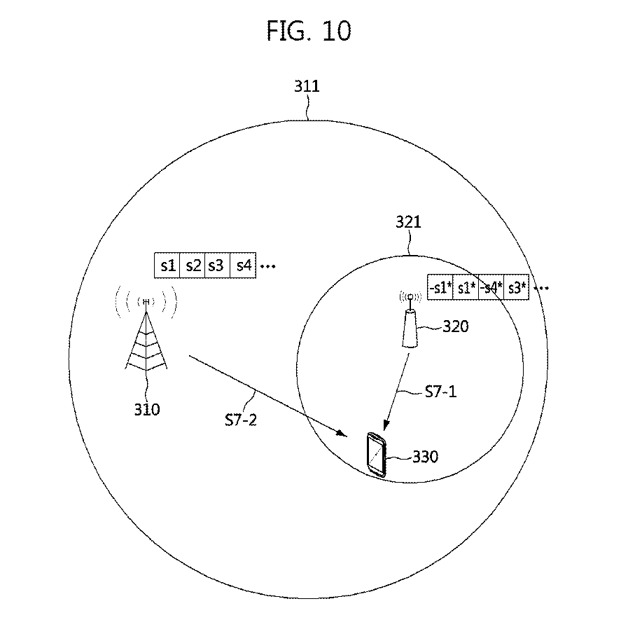

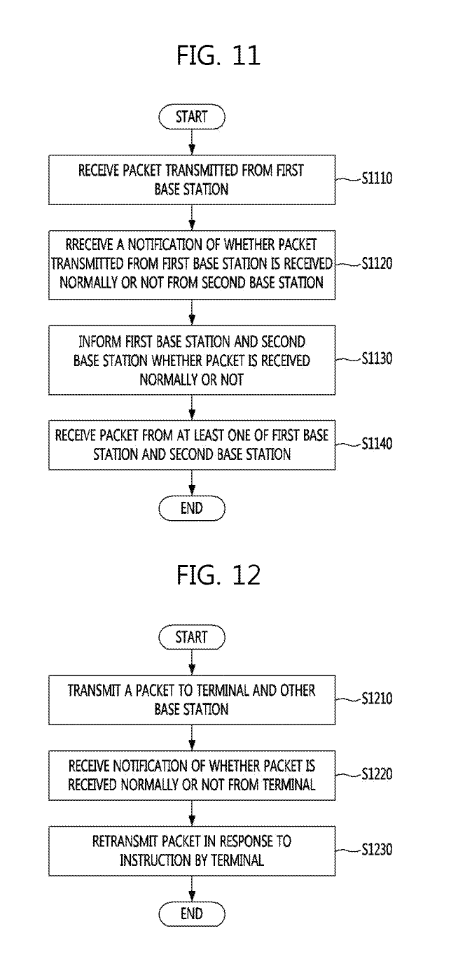

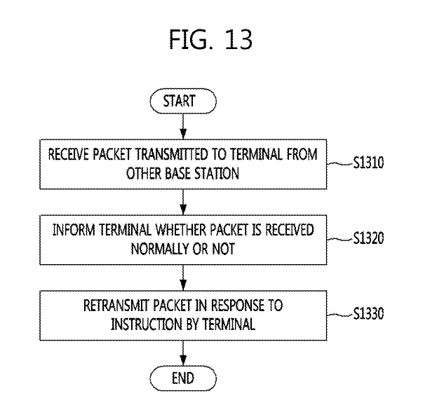

Meanwhile, FIG. 3 to FIG. 5, FIG. 7, FIG. 9 and FIG. 10 each show a conceptual diagram for explaining a method of packet retransmission in a heterogeneous network environment according to an embodiment of the present invention, and FIG. 2, FIG. 6 and FIG. 8 each show a timing diagram for explaining a method of packet retransmission in a heterogeneous network environment according to an embodiment of the present invention. It will be described with reference to FIGS. 2 to 10 along with FIG. 1.

Referring to FIG. 1, a method of packet retransmission in a heterogeneous network environment according to an embodiment of the present invention may include transmitting a packet from a first base station to a terminal and a second base station (S110), informing, by the second base station, the terminal whether the packet is received normally or not (S120), and informing, by the terminal, the first base station and the second base station whether the packet is received normally or not (S130).

Referring to FIG. 3, a first base station 310 is mainly a high power node, which may be a macrocell base station having relatively large coverage 311. A second base station 320 is mainly a low power node, which may be a base station having picocell coverage 321 overlapping the coverage of the first base station. The second base station can receive the same packet as the packet transmitted from the first base station to a terminal 330.

The second base station 320 may be at least one of a relay, a picocell base station, and a femtocell base station. As mentioned previously, the second base station 320 may receive the same packet as the packet transmitted from the first base station to a terminal 330. Thus, the term “base station” used in the second base station refers to a functional representation of a node performing forward transmission to the terminal If UE relaying is possible, note that the term “base station” may be used to indicate a relay terminal Typically, the second base station is operated as a relay terminal or a relay base station. If the picocell base station or the femtocell base station may receive and retransmit the same packet as the packet transmitted from the macro base station to the terminal, the picocell base station or the femtocell base station may be the second base station according to an embodiment of the present invention.

In operation S110, at t=0, the first base station 310 transmits a first packet (i=0) along with resources Mf(0, 0) (S1-1 and S1-2 in FIG. 3). After a predetermined transmission delay, the first packet reaches the second base station 320 as Pf(1,0) and reaches the terminal 330 as Mf(0,0).

In operation S120, the second base station 320 receives and decodes a packet transmitted from the first base station and determines whether or not the packet has an error. If the second base station 320 determines that the packet has no error, the second base station 320 transmits an ACK signal (R_ACK: Relay Acknowledgement) to the terminal (S2 in FIG. 3). In such a case, if the second base station decodes the received packet normally without error, the second base station may be configured to buffer the received packet into a buffer within the second base station.

On the other hand, in FIG. 2, only an ACK signal to be transmitted for Pf(3, 1) received by the second base station 320 for a packet Mf(2, 1) transmitted from the first base station is shown, and ACK/NACK signals for the remaining packets Mf(0, 0) to Mf(14, 6) are omitted. If the second base station 320 receives the packet transmitted from the first base station 310 normally, the second base station may not transmit an ACK signal to the terminal, and only if the second base station 320 fails to receive the packet transmitted from the first base station 310 normally, the second base station may be configured to transmit a NACK signal to the terminal, and vice versa.

In operation S130, the terminal receives and decodes a packet transmitted from the first base station and determines whether or not the packet has an error. If the terminal determines that the packet has no error, the terminal transmits an ACK signal to the first base station and the second base station (S3-1 and S3-2 in FIG. 3).

Referring to FIG. 2, the terminal receiving packets (Mf (0, 0), Mf (4, 2), Mf (6, 3), Mf (10, 4), Mf (12, 5), Mf (14, 6)) transmitted from the first base station normally and transmitting an ACK signal to the first base station and the second base station by performing operation S110 to operation S130 will be described.

If the terminal determines that the packet received from the first base station has an error upon decoding the packet in operation S130, the terminal transmits a NACK signal to the first base station and the second base station. Meanwhile, if the terminal receives the packet transmitted from the first base station normally, the terminal may immediately transmit an ACK signal to the first base station and the second base station, and if the terminal fails to receive the packet transmitted from the first base station normally, the terminal may transmit a NACK signal to the first base station and the second base station after the terminal receives an ACK signal or a NACK signal from the second base station. This is because whether or not the second base station performs retransmission of the packet is determined according to whether or not the second base station receives the packet transmitted from the first base station normally.

Referring to FIG. 4, a process (S3-3, S3-4) in which the terminal transmits a NACK signal to the first base station and the second base station will be described. In a conceptual diagram shown in FIG. 4, processes for transmission and reception of S1-1, S1-2 and S2 are the same as the process of the conceptual diagram shown in FIG. 3.

When the terminal detects an error in the received packet (or Mf(2, 1) in FIG. 2 is an error packet, for example), the terminal may transmit information (Cid) designating a base station to perform retransmission for the erroneous packet along with a NACK signal to the first base station (S3-4) and the second base station (S3-3). Further, the NACK signal may be transmitted by including wireless channel information for the first base station and the second base station.

In an example, the channel information may be information obtained by measuring a wireless channel, and the information (Cid) designating a base station to perform retransmission may be information designating a base station having a relatively better channel condition of the first base station and the second base station. For example, the Cid may be a Cell ID of a base station having a relatively better channel condition between the first base station and the second base station, and may use any value that is able to specify the first base station or the second base station. However, an example of the Cid is not necessarily limited to designation of a base station having a relatively better channel condition, and the Cid may be defined to designate a base station to perform retransmission by considering comprehensively and extensively predetermined rules, priorities, and so on.

In the following description, it is assumed that Cid=0 indicates that a base station to perform retransmission is a first base station, and Cid=1 indicates that a base station to perform retransmission is a second base station. In the above operation S120 (the process S2 in FIG. 3 and FIG. 4), when the second base station fails to receive a packet transmitted from the first base station normally and transmits a NACK signal to a terminal, the terminal may not transmit a NACK signal by designating the second base station (Cid=1) as a base station to perform retransmission. This is because the second base station fails to receive a packet transmitted from the first base station normally, and thus the second base station would not buffer a packet transmitted from the first base station.

In operation S140, it may be determined which of the first base station and the second base station having received a NACK signal from the terminal is to perform retransmission on the basis of the information (Cid) designating a base station to perform retransmission for the packet transmitted from the terminal along with the NACK signal, and a base station to perform retransmission designated according to the determination result may perform retransmission.

In such a case, it is preferable that the first base station and the second base station determine which base station is to perform retransmission by themselves on the basis of information (Cid) transmitted from the terminal, but it is also possible to determine a base station to perform retransmission under agreements between the base stations or predetermined rules on the basis of channel information transmitted from the terminal Furthermore, when a base station designated by information (Cid) transmitted from the terminal cannot retransmit, it is possible to disregard the information transmitted from the terminal and it is possible for the other base station to retransmit, based on agreements between the base stations or predetermined rules.

FIG. 5 and FIG. 7 illustrate conceptual diagrams for explaining processes in which a first base station performs packet retransmission and a process in which a second base station performs packet retransmission, respectively.

That is, FIG. 5 and FIG. 7 illustrate conceptual diagrams for explaining the retransmission of the first base station or the second base station, respectively, according to a determination of the terminal in operation S140, or in the basis of agreements between the base stations or predetermined rules. FIG. 6 illustrates a timing diagram for explaining the packet retransmission of the second base station with reference to FIG. 7.

Referring to FIG. 5 as an example, when the information (Cid) designating a base station to perform retransmission and which is included in the NACK signal transmitted from the terminal in operation S120 indicates the first base station (Cid=0), the first base station retransmits a packet.

The first base station 310 transmits a retransmission packet to the terminal and the second base station (S4-1, S4-2). The timing diagram in FIG. 2 illustrates that the first base station retransmits a retransmission packet Mf(8, 1) for a packet Mf(2, 1).

The second base station 320 may be configured to receive a packet retransmitted from the first base station, decode the retransmitted packet, determine whether or not the retransmitted packet has an error, and decide to retransmit an ACK signal or a NACK signal to the terminal according to the determination result. It is therefore possible to retransmit a predetermined number of times (for example, three or four times). In other words, when a packet retransmitted from the first base station has an error, the same process as the process starting from operation S110 of FIG. 1 may be performed repeatedly.

Meanwhile, referring to FIG. 7 as an example, when the information (Cid) designating a base station to perform retransmission and which is included in the NACK signal transmitted from the terminal in operation S120 indicates the second base station (Cid=1), the second base station retransmits a packet.

The second base station buffers a packet transmitted from the first base station and transmits the packet as a retransmission packet (S4-3 in FIG. 7, Pf(7, 1) in the timing diagram of FIG. 6).

The terminal may be configured to receive a packet (Pf(7, 1) received by the terminal in the timing diagram of FIG. 6) retransmitted from the second base station, to decode the retransmitted packet, to determine whether or not the retransmitted packet has an error, and to decide to transmit an ACK signal or a NACK signal to the second base station according to the determination result (S6 in FIG. 7). The second base station may be configured to repeatedly perform a second retransmission and a third retransmission according to an ACK signal or a NACK signal transmitted from the terminal

Although an exemplary case in which one base station performs retransmission of a packet of the first base station and the second base station receiving a NACK signal transmitted from the terminal has been described, it would possible for the first base station and the second base station to transmit with a JP transmission scheme of CoMP transmission. When the terminal is able to receive a packet with JP technology, it is possible to increase a probability of successful reception for the retransmitted packet in the terminal using the JP transmission scheme at the first base station and the second base station.

FIG. 9 and FIG. 10 illustrate conceptual diagrams for explaining processes in which the first base station and the second base station retransmit a packet to the terminal using the JP transmission, respectively. FIG. 8 is a timing diagram for explaining a process in which the first base station and the second base station retransmit a packet to the terminal using the JP transmission.

FIG. 9 illustrates a conceptual diagram for explaining an exemplary process in which the first base station and the second base station retransmit a packet to the terminal using the JP transmission.

Referring to FIG. 9, the first base station and the second base station, after receiving an indication of whether or not a packet is received normally from the terminal in operation S130 of FIG. 1, may schedule a resource based on Cid information and channel information transmitted from the terminal, and then both of the base stations may retransmit a packet by agreements between the base stations.

In an example, if the terminal 330 is capable of JP of CoMP among LTE Release 10 terminals, the first base station and the second base station may simultaneously transmit retransmission packets at the same frequency and time (i.e., same resource) (S7-1 and S7-2 transmission in FIG. 9, Mf(8, 1) and Pf(8, 1) in the timing diagram of FIG. 8), and the terminal may combine the signals with a JP function.

Furthermore, as a specific example of the CoMP JP transmission, it is possible to increase the probability of successful reception for the retransmitted packet in the first base station and the second base station with transmission of STBC, SFBC, and so on using Alamouti coding as a distributed antenna MIMO transmission scheme.

FIG. 10 illustrates a conceptual diagram for explaining another exemplary process in which the first base station and the second base station retransmit packets to the terminal using the JP transmission.

Referring to FIG. 10, the first base station and the second base station, after receiving an indication of whether or not a packet is received normally from the terminal in operation S130 of FIG. 1, may schedule a resource based on Cid information and channel information transmitted from the terminal, and then both of the base stations may retransmit a packet by agreements between the base stations.

As in the case of FIG. 9, if the terminal 330 is capable of JP of CoMP among LTE Release 10 terminals, the first base station and the second base station may simultaneously transmit retransmission packets at the same frequency and time (i.e., same resource) (S7-1 and S7-2 transmission in FIG. 9, Mf(8, 1) and Pf(8, 1) in the timing diagram of FIG. 8), and the terminal may combine the signals with a JP function. At this time, as a specific example of the CoMP JP transmission, it is possible to increase the probability of successful reception for the retransmitted packet in the first base station and the second base station through the transmission of STBC, SFBC, and so on using Alamouti coding as a MIMO transmission scheme.

In the following description, a method of packet retransmission in a heterogeneous network environment according to an embodiment of the present invention, and more particularly a method of operating base stations constituting the heterogeneous network environment and a method of operating a terminal in the heterogeneous network environment will be described. In the discussion below, a detailed description of a method of operating the first base station and the second base station is omitted because it is identical to the description above. Likewise, it will be described referring to the conceptual diagrams and timing diagrams in FIG. 2 to FIG. 10.

FIG. 11 is a flow chart for explaining a method of packet reception of a terminal in a heterogeneous network environment according to an embodiment of the present invention.

Referring to FIG. 11, a method of packet reception of a terminal according to an embodiment of the present invention includes receiving a packet transmitted from a first base station (S1110), receiving confirmation of whether the packet transmitted from the first base station is received normally or not from a second base station having coverage overlapping coverage of the first base station (S1120), informing the first base station and the second base station whether the packet is received normally or not (S1130), and if a determination result of whether the packet is received normally or not is a NACK, receiving the packet from at least one of the first base station and the second base station.

Referring again to FIG. 3 and FIG. 4, the terminal 330 receives a packet from the first base station in operation S1110 (S1-2), and receives confirmation of whether the packet transmitted by the first base station is received normally or not (ACK/NACK) from the second base station in operation 1120 (S2).

The terminal informs the first base station and the second base station whether the packet transmitted by the first base station is received normally or not (ACK/NACK) again. Specifically, the terminal notifies an ACK signal when the packet is received normally (S3-1, S3-2), and the terminal notifies a NACK signal when the packet is not received normally (S3-3, S3-4).

In such a case, when the terminal notifies the NACK signal in operation S1130, the terminal may transmit the NACK signal including at least one of information about wireless channel quality between the terminal and the base stations and information (Cid) designating a base station to perform packet retransmission.

Finally, the terminal may be configured to receive a packet again for the erroneous packet from at least one of the first and second base stations receiving a notification of the NACK signal from the terminal in operation S1140 (FIG. 5 or FIG. 7). Specifically, the terminal may be configured to receive a packet from a base station which is determined to perform packet retransmission of the first base station and the second base station, and the base station to perform packet retransmission is determined using at least one of information about wireless channel quality and information (Cid) designating a base station to perform packet retransmission which is receiving a notification from the terminal in operation 1130. Alternatively, the terminal may be configured to receive a packet retransmitted from the first base station and the second base station using the CoMP JP transmission (FIG. 9).

In such a case, in the CoMP JP transmission of the first base station and the second base station, it is possible to increase the probability of successful reception for the retransmitted packet by using the Alamouti coding, etc. as a distributed antenna MIMO transmission scheme.

FIG. 12 is a flow chart for explaining an exemplary method of packet retransmission of a base station in a heterogeneous network environment according to an embodiment of the present invention.

Referring to FIG. 12, an exemplary method of packet retransmission of a base station in a heterogeneous network environment according to an embodiment of the present invention includes transmitting a packet to another base station having coverage overlapping coverage of the base station and a terminal located within the overlapping coverage of the other base station (S1210), receiving a notification of whether the packet is received normally or not from the terminal (S1220), and retransmitting the packet in response to an instruction of the terminal (S1230).

Referring again to FIG. 3 and FIG. 4, the base station (310 in FIG. 3 and FIG. 4) transmits a packet to the other base station (320 in FIG. 3 and FIG. 4) (S1-1) as well as to the terminal (330 in FIG. 3 and FIG. 4) (S1-2) in operation S1210. Thus, the base station may be a macrocell base station having relatively large coverage as a high power node, and the other base station may be a base station having relatively small coverage as a low power node. In this case, the other base station may be at least one of a relay, a picocell base station, and a femtocell base station configured to receive a packet transmitted from the base station like the terminal 330.

Furthermore, the base station (e.g., the first base station of FIG. 3 and FIG. 4) receives a notification of whether the packet transmitted from the base station is received normally or not from the terminal in operation S1120. At this time, when the terminal receives the packet transmitted from the base station normally, the base station receives a notification of an ACK signal (S3-2). Meanwhile, when the terminal fails to receive the packet transmitted from the base station normally, the base station receives a notification of a NACK signal (S3-4).

In such a case when receiving a NACK signal from the terminal, the base station may receive a notification of at least one of information about wireless channel quality between the base station and the terminal and between the other base station and the terminal and information (Cid) designating a base station to perform packet retransmission along with the NACK signal.

Finally, the base station may configured to retransmit a packet by determining itself to perform packet retransmission, using at least one of information about wireless channel quality between the base station receiving the packet from the terminal and the terminal and between the other base station and the terminal and information (Cid) designating a base station to perform packet retransmission in operation S1230 (see FIG. 5). Alternatively, the base station and the other base station may be configured to retransmit packets using a CoMP JP transmission scheme (see FIG. 9 and FIG. 10).

In this case, in CoMP JP transmission of the base station and the other base station having coverage overlapping coverage of the base station, it is possible to increase the probability of successful reception of the terminal for the retransmitted packet by employing the Alamouti coding using a distributed antenna MIMO transmission scheme (see FIG. 10).

FIG. 13 is a flow chart for explaining another exemplary method of packet retransmission in a heterogeneous network environment according to an embodiment of the present invention.

Referring to FIG. 13, another exemplary method of packet retransmission of a base station in a heterogeneous network environment according to an embodiment of the present invention includes receiving, by the base station, a packet to be transmitted to a terminal within coverage of the base station from another base station having coverage overlapping the coverage of the base station (S1310), informing the terminal whether the packet is received normally or not (S1320), and retransmitting the packet in response to an instruction of the terminal (S1330).

Referring again to FIG. 3 and FIG. 4, the base station (the second base station in FIG. 3 and FIG. 4) receives a packet transmitted to the terminal from the other base station (the first base station in FIG. 3 and FIG. 4), and the packet is transmitted by the other base station (S1-1 in FIG. 3 and FIG. 4) in operation S1310. Thus, the base station may be a base station having relatively small coverage as a low power node, and may be at least one of a relay, a picocell base station, and a femtocell base station configured to receive a packet transmitted from the other base station like the terminal 300. Meanwhile, the other base station may be a macrocell base station having relatively large coverage as a mainly high power node.

The base station may notify the terminal of whether the packet transmitted from the other base station is received normally or not in operation 1320 (S2 in FIG. 3 and FIG. 4). When the packet is received normally, the base station may be configured to buffer the received packet for preparing retransmission to the terminal.

Furthermore, the base station (the second base station in FIG. 3 and FIG. 4) may be configured to retransmit a packet by determining itself to perform packet retransmission, using at least one of information about wireless channel quality between the base station receiving the packet from the terminal and the terminal and between other base station and the terminal and information (Cid) designating a base station to perform packet retransmission in operation S1330 (see FIG. 5). Alternatively, the base station and the other base station may be configured to retransmit packets using a CoMP JP transmission scheme (see FIG. 9 and FIG. 10).

In this case, in CoMP JP transmission of the base station and the other base station having coverage overlapping coverage with the base station, it is possible to increase the probability of successful reception of the terminal for the retransmitted packet by employing the Alamouti coding using a distributed antenna MIMO transmission scheme (see FIG. 10).

In accordance with a particular embodiment, a method of retransmitting and receiving a packet allows the optimization of a HARQ process and scheduling scheme to efficiently utilize a relay and radio resources, thereby leading to a maximum capacity and quality of wireless network.

Specifically, in accordance with a method of retransmitting a packet of an embodiment of the present invention, the retransmission of erroneous packets can be performed not only at a macro base station but also at a relay base station. Furthermore, since the retransmission is performed at a better base station, it is possible to improve the efficiency and performance of the overall system and reduce the load of the macro base station. In particular, when the retransmission is performed with JP transmission of the macro base station and the relay base station, it is possible to increase the success probability of the retransmission, thereby improving the efficiency and performance of the overall system.

While the example embodiments of the present invention and their advantages have been described in detail, it should be understood that various changes, substitutions and alterations may be made herein without departing from the scope of the invention.

What is claimed is:

1. A method of retransmitting a packet in a heterogeneous network environment, comprising:
transmitting, by a first base station, a packet to a terminal and a second base station;
informing, by the second base station, the terminal whether the packet is received normally or not; and
informing, by the terminal, the first base station and the second base station whether the packet is received normally or not.

2. The method of claim 1, wherein coverage of the second base station overlaps coverage of the first base station, and the terminal is located within the coverage of the first and second base stations.

3. The method of claim 2, wherein the first base station is a macrocell base station, and the second base station is at least one of a relay base station, a relay terminal, a picocell base station and a femtocell base station capable of receiving the packet transmitted from the first base station.

4. The method of claim 1, further comprising, when the second base station receives the packet normally, buffering the packet.

5. The method of claim 1, wherein, when the terminal informs the first base station and the second base station whether the packet is received normally or not, if a determination result of whether the packet is received normally or not is a NACK, the terminal informs the first base station and the second base station of information designating a base station to perform the packet retransmission.

6. The method of claim 5, wherein, when the second base station informs the terminal that the packet fails to be received normally, the terminal excludes the second base station of the base stations from performing the packet retransmission.

7. The method of claim 5, further comprising retransmitting the packet to the terminal by a base station of the first base station and the second base station using information designating the base station to perform the packet retransmission.

8. The method of claim 1, further comprising simultaneously retransmitting the packet, by the first base station and the second base station, using the same time-frequency resource through joint processing (JP).

9. A method of receiving a packet in a heterogeneous network environment as an operating method of the terminal located within overlapping coverage of a first base station and a second base station, comprising:
receiving a packet transmitted from the first base station;
receiving a notification of whether the packet transmitted from the first base station is received normally or not from the second base station;
informing the first base station and the second base station whether the packet is received normally or not; and
receiving, when a determination result of whether the packet is normally received or not is a NACK, the packet from at least one base station of the first base station and the second base station.

10. The method of claim 9, wherein the first base station is a macrocell base station, and the second base station is at least one of a relay base station, a relay terminal, a picocell base station and a femtocell base station capable of receiving the packet transmitted from the first base station.

11. The method of claim 9, wherein, when the terminal informs the first base station and the second base station whether the packet is received normally or not, if a determination result of whether the packet is normally received or not is a NACK, the terminal informs the first base station and the second base station of information designating a base station to perform packet retransmission.

12. The method of claim 11, wherein, when the terminal is notified that the packet has not received normally from the second base station, the terminal excludes the second base station of the base stations from performing the packet retransmission.

13. The method of claim 9, wherein the receiving of the packet from at least one of the first base station and the second base station includes simultaneously receiving the packet from the first base station and the second base station using the same time-frequency resource through joint processing (JP).

14. A method of retransmitting a packet at a base station in a heterogeneous network environment, comprising:
transmitting a packet to a terminal located within coverage of its base station and another base station different from the base station, the coverage of the other base station being overlapping coverage of the base station;
receiving a notification of whether the packet is received normally or not from the terminal; and
retransmitting the packet in response to an instruction by the terminal

15. The method of claim 14, wherein the base station is a macrocell base station, and the other base station is at least one of a relay base station, a relay terminal, a picocell base station and a femtocell base station capable of receiving the packet transmitted from the base station.

16. The method of claim 14, wherein the retransmitting of the packet includes simultaneously retransmitting, by the base station, the packet together with the other base station using the same time-frequency resource through joint processing (JP).

17. A method of retransmitting a packet at a base station in a heterogeneous network environment, comprising:
receiving a packet transmitted to a terminal located within coverage of the base station from another base station different from the base station, the coverage of the other base station overlapping coverage of the base station;
informing the terminal whether the packet is received normally or not; and
retransmitting the packet in response to an instruction by the terminal

18. The method of claim 17, wherein the base station is at least one of a relay base station, a relay terminal, a picocell base station and a femtocell base station capable of receiving the packet transmitted from the other base station.

19. The method of claim 17, further comprising buffering the packet when the base station normally receives the packet.

20. The method of claim 17, wherein the retransmitting of the packet includes simultaneously retransmitting, by the base station, the packet together with the other base station using the same time-frequency resource through joint processing (JP).
